(19) United States
(12) Patent Application Publication
(10) Pub. No.: US 2005/0062830 A1
(43) Pub. Date: Mar. 24, 2005

(54) Light irradiating unit and optical fixing unit

(75) Inventors: Tomoko Taki, Saitama (JP); Akira Mizuyoshi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 10/944,183

(22) Filed: Sep. 20, 2004

(30) Foreign Application Priority Data
Sep. 22, 2003 (JP) 2003-330590

(51) Int. Cl. B41J 2/385

(52) U.S. Cl. 347/130

(57) ABSTRACT

A width of an LED array in a scanning direction is determined in accordance with a width of thermosensitive recording paper. A plurality of LEDs is arranged in the LED array in such a way that an arranging pitch between the LEDs are lessened from a center area toward side edge areas of the LED array. Thus, an arranging density of the LEDs increases from the center area toward the side edge areas of the LED array, so that radiated fixing light becomes uniform in a width direction of the thermosensitive recording paper. As a result, unevenness in fixing is prevented. Further, irradiation efficiency in the side edge areas of the LED array is improved by providing reflectors on both side edges of the LED array. Accordingly, the unevenness in fixing is prevented more efficiently.

### BACKGROUND OF THE INVENTION

1. Field of the Invention

The present invention relates to a light irradiating unit, and an optical fixing unit provided in a thermal printer.

2. Background Arts

One or more optical fixing units, which fix images by irradiating fixing light to thermally recorded thermosensitive recording paper, are provided as light irradiating units in a thermal printer.

An optical fixing unit, which uses a light-emitting element array aligned with a plurality of light-emitting elements as a fixing light source, is suggested. (For instance, see Japanese Patent Laid-Open Publication No. 11-260122.) A lengthwise direction of the light-emitting element array is placed along a width direction of the thermosensitive recording paper. A length of the light-emitting element array is determined in accordance with a width of the thermosensitive recording paper. Optical fixing is performed by, for instance, irradiating the fixing light to a whole record area of the thermosensitive recording paper while feeding it in a sub-scanning direction which is perpendicular to the width direction (a scanning direction) of the thermosensitive recording paper.

However, an amount of the fixing light radiated outside of the record area increases from a center area of the light-emitting element array facing a center portion of the record area of the thermosensitive recording paper toward side edge areas of the light-emitting element array facing side edge portions of the record area of the thermosensitive recording paper. As a result, the amount of the fixing light irradiated to the record area becomes nonuniform, so there arises a problem in that unevenness in fixing is generated in the width direction of the thermosensitive recording paper.

### SUMMARY OF THE INVENTION

An object of the present invention is to provide a light irradiating device which can prevent variations in an amount of irradiated light in a width direction of a sheet-like material.

Another object of the present invention is to provide a thermal printer which can prevent unevenness in fixing in a width direction of thermosensitive recording paper by using the light irradiating device as an optical fixing unit.

In order to achieve the above objects, the light irradiating device of the present invention is formed of a plurality of light-emitting elements arranged on a substrate, and comprises a light-emitting element array which has a length in accordance with a width of the sheet-like material. An arranging density of the light-emitting elements is higher in side edge areas of the light-emitting element array facing side edge portions of the sheet-like material than in a center area of the light-emitting element array facing a center portion of the sheet-like material.

In a preferred embodiment, an arranging pitch between the light-emitting elements in a first direction of the light-emitting element array, which is approximately parallel to the width direction of the sheet-like material, is lessened from the center area toward the side edge areas of the light-emitting element array. It is also possible to lessen the arranging pitch between the light-emitting elements in a second direction, which is approximately perpendicular to the width direction of the sheet-like material, from the center area toward the side edge areas of the light-emitting element array. It is preferable to provide reflectors on both side edges of the light-emitting element array to reflect light, which is radiated outside of the sheet-like material, toward the sheet-like material.

Instead of changing the arranging density of the light-emitting elements, a pair of reflection planes may be provided on both sides of each of the light-emitting element in a parallel direction to the width direction of the sheet-like material, and angles of the reflection planes may be changed. The pair of reflection planes comprises a first reflection plane, which is on the side edge area side, and a second reflection plane, which is on the center area side, and reflects light radiated from a lateral surface of corresponding light-emitting element toward the sheet-like material. An angle of the first reflection plane with respect to a normal of the substrate is increased from the center area toward the side edge areas of the light-emitting element array. Further, it is preferable to make an angle of the second reflection plane with respect to the normal of the substrate smaller from the center area toward the side edge areas of the light-emitting element array.

The light irradiating device can be applicable to the optical fixing unit for use in a thermal printer.

According to the present invention, the arranging density of the light-emitting elements increases from the center area to the side edge areas of the light-emitting element array, so that it becomes possible to prevent the variations in the amount of irradiated light caused by radiating part of light to the outside of the sheet-like material. Further, the unevenness in fixing can be prevented in the width direction of the thermosensitive recording paper by using the light irradiating device as the fixing unit for use in the thermal printer.

### BRIEF DESCRIPTION OF THE DRAWINGS

The above objects and advantages of the present invention will become apparent from the following detailed descriptions of the preferred embodiments when read in association with the ac companying drawings, which are given by way of illustration only and thus do not limit the present invention. In the drawings, the same reference numerals designate like or corresponding parts throughout the several views, and wherein:

FIG. 1 is a schematic illustration showing a structure of a color thermal printer according to the present invention;

FIG. 2 is a partial plan view showing an outline of a structure of each fixing unit for yellow and magenta;

FIG. 3 is a partial section view of the fixing unit along a scanning direction, in which arranging pitches between LEDs are changed in the scanning direction;

FIG. 4 is an outlined plan view of the fixing unit, in which an arranging density of the LEDs is low in a center area; and

FIG. 5 is a partial section view of the fixing unit along the scanning direction, in which angles of reflection planes provided on both sides of respective LEDs are changed.

### DETAILED DESCRIPTION OF THE EMBODIMENTS

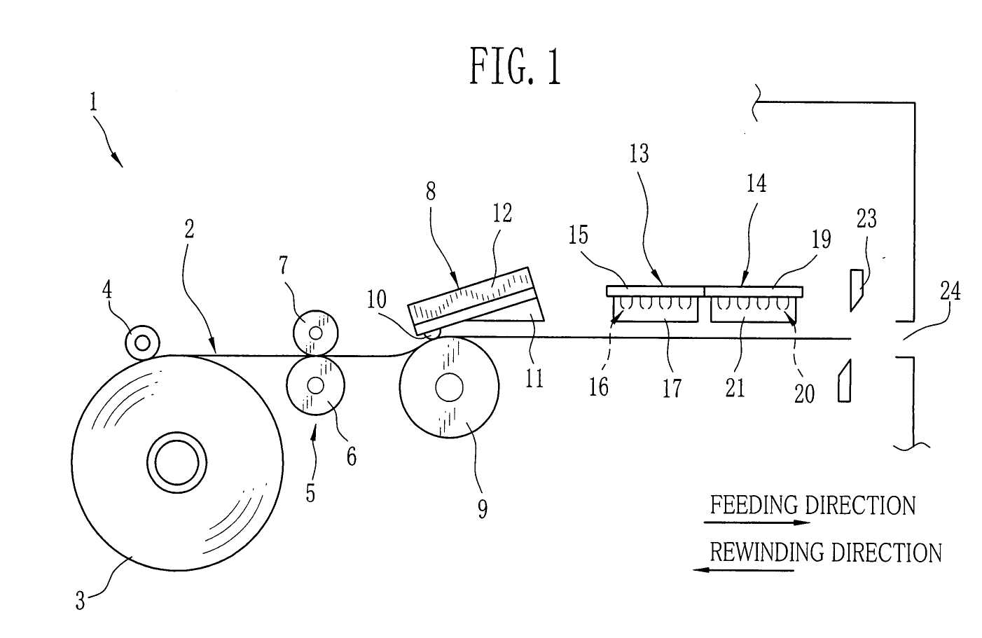

As shown in FIG. 1, a color thermal printer 1 uses a long strip of color thermosensitive recording paper 2 as a recording medium. The color thermosensitive recording paper 2 is set in the color thermal printer 1 in the form of a recording paper roll 3 which is wound in a roll form.

A roller 4 comes in contact with an outer periphery of the recording paper roll 3, and is driven by a feeding motor (not shown). When the roller 4 is rotated in a counterclockwise direction in a drawing, the recording paper roll 3 is rotated in a clockwise direction in the drawing, so that the color thermosensitive recording paper 2 is advanced from the recording paper roll 3. On the contrary, when the roller 4 is rotated in the clockwise direction in the drawing, the recording paper roll 3 is rotated in the counterclockwise direction in the drawing, so that the color thermosensitive recording paper 2 is rewound around the recording paper roll 3.

A feeding roller pair 5 is disposed in the proximity of the recording paper roll 3. The feeding roller pair 5 interposes and feeds the color thermosensitive recording paper 2. The feeding roller pair 5 is constituted of a capstan roller 6 and a pinch roller 7. The feeding motor (not shown) drives and rotates the capstan roller 6. The pinch roller 7 is pressed against the capstan roller 6. The feeding roller pair 5 reciprocates the color thermosensitive recording paper 2 in a feeding direction, which is toward the right in the drawing, and in a rewinding direction, which is toward the left in the drawing.

As well known, the color thermosensitive recording paper 2 comprises thermosensitive coloring layers of cyan, magenta and yellow, which are overlaid on a support in this order. The yellow thermosensitive coloring layer, which is the uppermost layer, has the highest heat sensitivity and is developed by low thermal energy. The cyan thermosensitive coloring layer, which is the lowermost layer, has the lowest heat sensitivity and is developed by high thermal energy. The yellow thermosensitive coloring layer loses its coloring ability upon radiating near-ultraviolet ray with a wavelength of 420 nm. The magenta thermosensitive coloring layer is developed by an intermediate thermal energy ranged between those of yellow and cyan thermosensitive coloring layers, and loses its coloring ability upon radiating the near-ultraviolet ray with a wavelength of 365 nm.

A thermal head 8 and a platen roller 9 are disposed on a downstream side of the feeding roller pair 5 in the feeding direction, so as to interpose a feeding passage of the color thermosensitive recording paper 2 between them. The thermal head 8 is disposed in an upper portion of the feeding passage of the color thermosensitive recording paper 2, and has a heating element array 10 in which a plurality of heating elements is aligned along the scanning direction.

A head cover 11 is attached to a lower portion of the thermal head 8. A radiation plate 12 is attached to an upper portion of the thermal head 8. The head cover 11 guides the color thermosensitive recording paper 2 toward the heating element array 10. The radiation plate 12 radiates heat generated by the thermal head 8 to the outside.

The platen roller 9 is disposed below the feeding passage facing the heating element array 10. Further, the platen roller 9 is moved up or down by the use of a shifting mechanism such as a cam, a solenoid and the like, and is biased by a spring (not shown) so as to be pressed against the thermal head 8. When rewinding or ejecting the color thermosensitive recording paper 2, the platen roller 9 is moved in a downward direction by the shifting mechanism so that a clearance is formed between the thermal head 8 and the platen roller 9.

The color thermosensitive recording paper 2 is interposed between the thermal head 8 and the platen roller 9 while being fed in the feeding direction by the feeder roller pair 5. Then, the heating element array 10 is heated to a predetermined temperature to develop each thermosensitive coloring layer of the color thermosensitive recording paper 2. The platen roller 9 is rotated in association with feeding of the color thermosensitive recording layer 2.

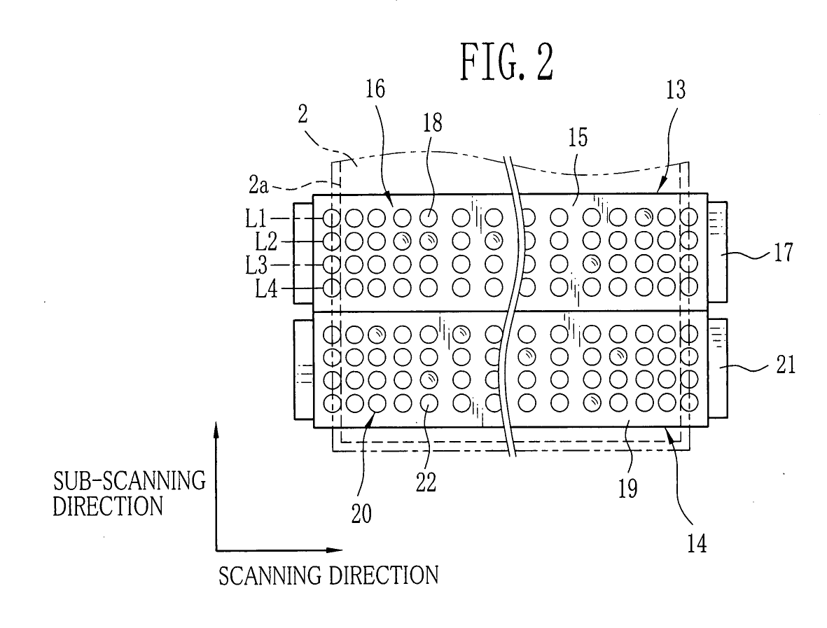

A fixing unit 13 for Y, which is a light source for fixing a yellow image, and a fixing unit 14 for M, which is a light source for fixing a magenta image, are disposed on a downstream side of the thermal head 8 in the feeding direction. The respective fixing units 13, 14 for Y and M optically fix each thermosensitive coloring layer by irradiating the fixing light, which has predetermined wavelength with respect to each thermosensitive coloring layer, to the whole record area 2a (see FIG. 2) of the color thermosensitive recording paper 2.

The fixing unit 13 for Y comprises a substrate 15, a light-emitting element (an LED) array 16 for yellow (Y), and reflectors 17. FIG. 2 is a plan view of each fixing unit 13, 14 for Y and M viewed from beneath the fixing units. The LED array 16 for Y is composed of light-emitting diodes (LEDs) 18 for yellow (Y) which are aligned along the scanning direction. The LED 18 for Y radiates the near-ultraviolet ray, a wavelength of a luminous peak of which is 420 nm. The fixing unit 13 for Y is disposed such that a lengthwise direction of the LED array 16 for Y coincides with the scanning direction. The LED array 16 for Y is aligned on the substrate 15, for instance, in four rows from the first row L1 to the fourth row L4. An LED of a flip-chip type, which is without a lead wire for connection, is used as the LED 18 for Y. Each LED 18 for Y is approximately equal in luminous intensity and irradiates the near-ultraviolet ray as the fixing light from a surface facing the color thermosensitive recording paper 2 (that is, a top surface) and a lateral surface.

In order to downsize the fixing unit, a width of the LED array 16 for Y in the scanning direction is determined in accordance with a width of the color thermosensitive recording paper 2. Therefore, an amount of light irradiated to the outside of the record area 2a of the color thermosensitive recording paper 2 increases from a center area of the LED array 16 for Y facing a center portion of the color thermosensitive recording paper 2 toward side edge areas of the LED array 16 for Y facing side edge portions of the color thermosensitive recording paper 2. For that reason, an amount of fixing light irradiated to the color thermosensitive recording paper 2 becomes nonuniform in a width direction, that results in unevenness in fixing. According to this embodiment, an arranging density of LEDs 18 for Y increases from the center area toward the side edge areas of the LED array 16 for Y by shortening an interval (arranging pitch) between LEDs 18 for Y.

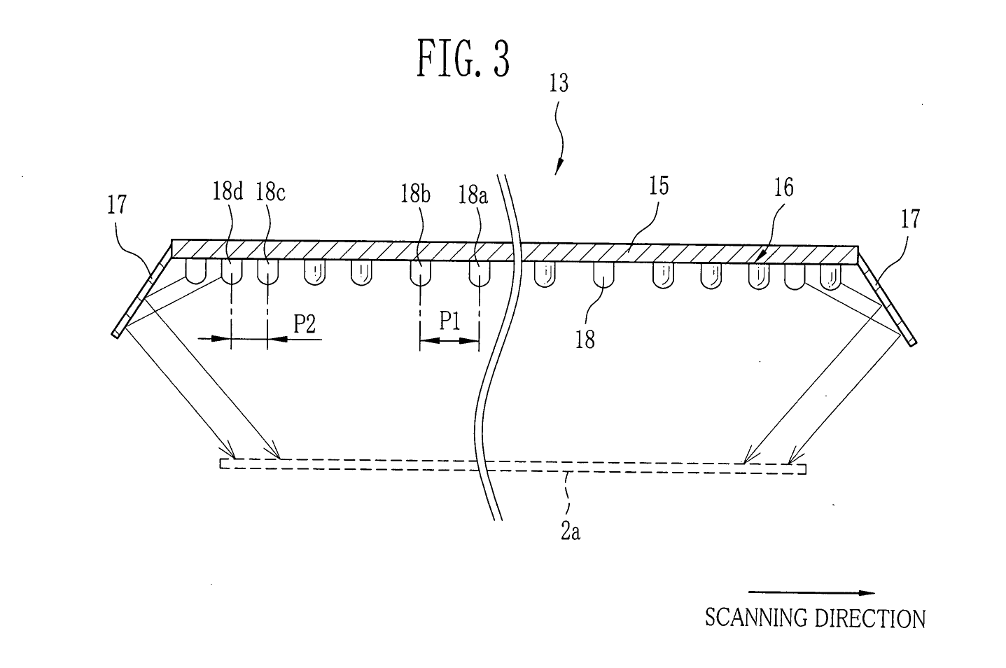

As shown in FIG. 3, when P1 is defined as an arrangement pitch between an LED 18a for Y and an LED 18b for Y situated in the center area of the LED array 16 for Y, and P2 is defined as an arrangement pitch between an LED 18c for Y and an LED 18d for Y situated in the side edge area of the LED array 16 for Y, P2 is set to be shorter than P1. Further, an arranging pitch between the LEDs 18, which are situated between the LED 18b in the center area and the LED 18c in the side edge area, is determined within a range between P1 and P2. The arranging pitch between the LEDs 18 for Y is lessened from the LED 18b for Y toward the LED 18c for Y.

As described above, the fixing light becomes uniform in the width direction of the color thermosensitive recording paper 2 as the arranging density of the LEDs 18 for Y increases from the center area toward the side edge areas of the LED array 16 for Y by shortening the arranging pitch between the LEDs 18 for Y. As a result, the unevenness in fixing is prevented in the width direction of the color thermosensitive recording paper 2.

Further, the reflectors 17 provided on both side edges of the LED array 16 for Y reflect the fixing light, which is radiated toward the outside of the record area 2a, to the record area 2a. Thus, irradiation efficiency of the side edge areas of the LED array 16 is improved in the side edge portions of the color thermosensitive recording paper 2 by providing the reflectors 17. Accordingly, the unevenness in fixing can be prevented effectively.

The fixing unit 14 for M has substantially equivalent configuration to the fixing unit 13 for Y. The fixing unit 14 for M comprises a substrate 19, a light-emitting element (LED) array 20 for magenta (M), and reflectors 21. The LED array 20 for M is composed of light emitting diodes (LEDs) 22 for magenta (M) that are aligned along the scanning direction. The LEDs 22 for M optically fix the magenta thermosensitive coloring layer by radiating ultraviolet rays, the wavelength of the luminous peak of which is 365 nm.

As in the same manner as the fixing unit 13 for Y, an arranging pitch between LEDs 22 for M is shortened in such a way that the arranging density of the LEDs 22 for M increases from a center area toward side edge areas of the LED array 20 for M. Thereby, the fixing light irradiated to the color thermosensitive recording paper 2 becomes uniform in the width direction, so that the unevenness in fixing is prevented in the width direction of the color thermosensitive recording paper 2. Further, reflectors 21, as with those of the fixing units 13 for Y, are also provided on both side edges of the LED array 20 for M. Accordingly, the unevenness in fixing can be prevented more effectively.

A cutter 23 and an ejection slot 24 are disposed on a downstream side of the fixing units 13, 14 for Y and M in the feeding direction. The cutter cuts the color thermosensitive recording paper 2 in a predetermined position. Then, a cut sheet of the thermally recorded color thermosensitive recording paper 2 is ejected through the ejection slot 24.

Next, an operation of the above embodiment is described. As shown in FIG. 1, when a print starting operation is initiated in the color thermal printer 1, the roller 4 is rotated and the color thermosensitive recording paper 2 is advanced to the feeding passage. When a front-end of the record area 2a of the color thermosensitive recording paper 2 reaches the heating element array 10 of the thermal head 8, the thermal recording of the yellow image is started.

After thermally recording the yellow image, a thermally recorded portion of the color thermosensitive recording paper 2 is sequentially advanced to the fixing unit 13 for Y, and is optically fixed.

As shown in FIGS. 2 and 3, uniform fixing light is irradiated in the width direction of the color thermosensitive recording paper 2 by using the LED array for Y 16, in which the LEDs 18 for Y are arranged at higher densities from the center area toward the side edge areas of the LED array 16 for Y. As a result, the unevenness in fixing is prevented in the width direction of the color thermosensitive recording paper 2.

After optical fixing of the yellow image, the color thermosensitive recording paper 2 is rewound to a print starting position, and a thermal recording of the magenta image is initiated. After thermal recording of the magenta image, the thermally recorded portion of the color thermosensitive recording paper 2 is sequentially advanced to the fixing unit 14 for M and is optically fixed. The LED array 20 for M, which has substantially equivalent configuration to the LED array 16 for Y, also irradiates the uniform fixing light to the color thermosensitive recording paper 2 in the width direction. Accordingly, the unevenness in fixing can also be prevented in the width direction of the color thermosensitive recording paper 2.

After optical fixing of the magenta thermosensitive coloring layer, the color thermosensitive recording paper 2 is rewound again, and a cyan image is thermally recorded on it. After the cyan image has been thermally recorded, the recorded portion of the color thermosensitive recording paper 2 is cut by the cutter 23 and ejected through the ejection slot 24.

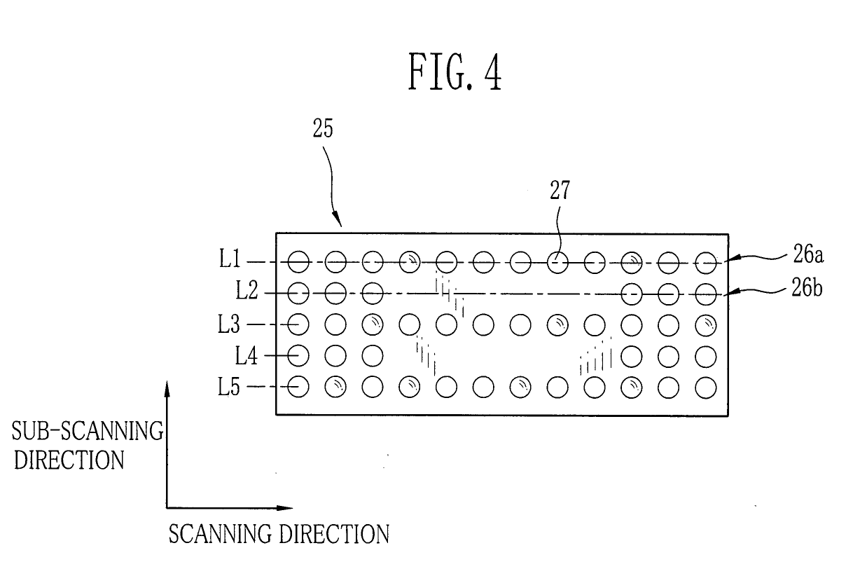

According to the above embodiment, an example of changing the arranging density of the LEDs has been described by changing the arranging pitch between the LEDs 18 of the LED array 16 and that between the LEDs 19 of the LED arrays 20; however, the arranging density of LEDs can be changed without changing the arranging pitch. As shown in FIG. 4, for instance, when using a fixing unit 25 composed of LED arrays having five rows from a first row L1 to a fifth row L5, an LED array 27 is disposed in each odd-numbered line L1, L3, and L5, and an LED array 26b is disposed in each even-numbered line L2 and L4. The LED array 27 has a plurality of LEDs 27 aligned with a constant arranging pitch from the center area to the side edge areas. On the other hand, the LED array 26b has no LEDs in a center area, but has LEDs 27 only in the side edge areas. Thus, as a whole, the arranging density of the LEDs is increased in the side edge areas in comparison to the center area without changing the arranging pitch between the LEDs in each row.

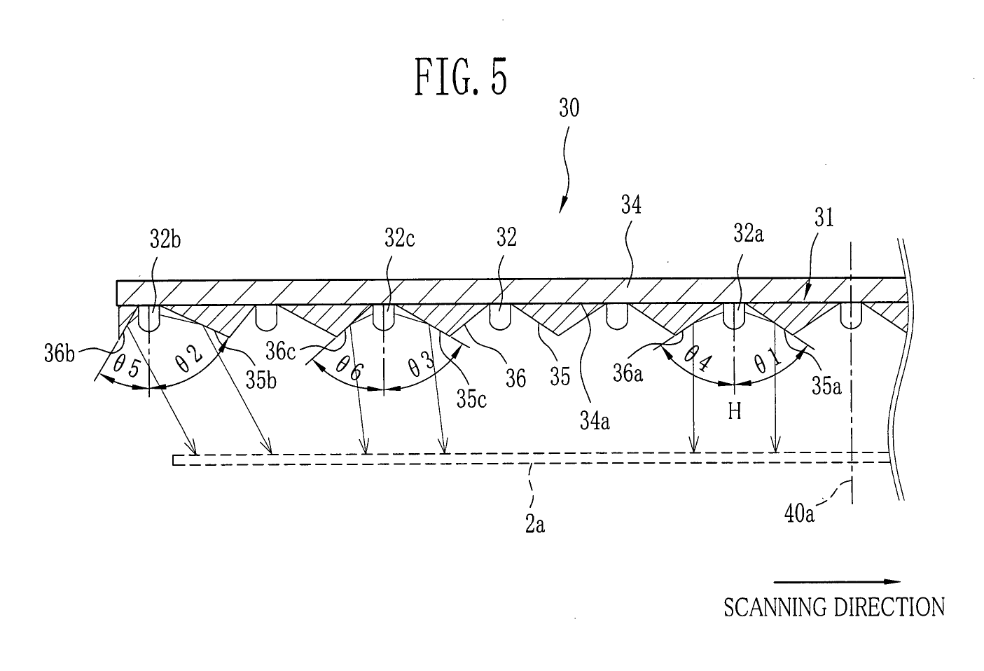

Next, another embodiment of the present invention is described (see FIG. 5). A plurality of flip-chip type LEDs 32, which constitutes an LED array 31, is implemented on a substrate surface 34a of a substrate 34. On both sides of each LED 32, a pair of reflection planes 35 and 36 is formed for reflecting light emitted from the LED 32. Therefore, a plurality of crest and trough portions is formed on the substrate surface 34a along the scanning direction. Each LED 32 is mounted on the trough portion of the substrate surface 34a. Thereby, the reflection planes 35 and 36 are disposed on the right and left sides of the LED 32. The reflection planes 35 and 36 are inclined in such a way that their sections form substantially V-shape in the scanning direction, and reflects the fixing light irradiated from a lateral side of each LED 32 toward the record area 2a of the color thermosensitive recording paper 2. Irradiation efficiency of each LED 32 is improved by providing the reflection planes 35 and 36.

Angles of reflection planes 35 and 36 with respect to a normal H of the substrate surface 34a change from a center area toward a side edge area of the LED array 31, and prevents the fixing light from being reflected to the outside of the color thermosensitive recording paper 2. The angles of reflection planes 35a and 36a of an LED 32a situated in the center area of the LED array 31 are determined so as to irradiate the reflected fixing light perpendicular to a portion facing the LED 32a. On the other hand, angles of reflection planes 35b and 36b, which are situated in a side end area of the LED array 31, are determined such that the reflected fixing light is inclined toward the center portion of the color thermosensitive recording paper 2.

When each angle of the pair of reflection planes 35 and 36 is designated as an angle θ with respect to the normal H of the substrate surface 34a, an angle of each reflection plane 35, which is situated nearer to the center portion of the color thermosensitive recording paper 2a with respect to each LED 32 (that is, on the right side in the drawing), is gradually increased from the center area toward the side edge area of the LED array 31. On the contrary, an angle of each reflection plane 36, which is situated nearer to the side edge portion, is gradually lessened from the center area toward the side edge area of the LED array 31. That is, the angle of each reflection plane 35, which is situated nearer to the center area, satisfies the following. When an angle of the reflection plane 35a of the LED 32a is designated as θ1, an angle of the reflection plane 35b of the LED 32b is designated as θ2, and an angle of a reflection plane 35c, which is situated between the LEDs 32a and 32b, is designated as θ3, a relationship among the angles θ1, θ2, and θ3 is θ2>θ3>θ1. On the contrary, an angle of each reflection plane 36, which is situated nearer to the side edge area, satisfies the following. When an angle of the reflection plane 36a of the LED 32a is designated as θ4, an angle of the reflection plane 36b of the LED 32b is designated as θ5, and an angle of a reflection plane 35c, which is situated between the LEDs 32a and 32b, is designated as θ6, a relationship among the angles θ4, θ5, and θ6 is θ4>θ6>θ5.

A right portion of the LED array 31 is not shown in FIG. 5; however, the reflection planes 35 and 36 of each LED 32 in the right portion and those in the left portion are symmetrical with respect to a centerline 40a. Angles of reflection planes 35 and 36 of each LED 32 with respect to the normal H in the right portion are also changed gradually toward the side edge area of the LED array 31.

Thus, the angle of each reflection plane, which is situated nearer to the center area, is gradually increased from the center area toward the side edge area of the LED array 31. On the contrary, the angle of each reflection plane, which is situated nearer to the side edge area, is gradually lessened. As a result, the optical fixing light becomes uniform in the width direction of the color thermosensitive recording paper 2. Therefore, the unevenness in fixing is prevented in the width direction of the color thermosensitive recording paper 2.

In the above embodiments of the present invention, an example of changing the arranging density of the LEDs and an example of changing the angle of each reflection plane disposed on both sides of each LED are described; however, it is possible to combine these two examples.

In the above embodiment, the flip-chip type LEDs 18, 22, and 32 are used to form the LED arrays 16, 20, and 31 respectively; however, the LED array may be formed by implementing the LEDs with lead wires on the substrate.

In the above embodiment, the thermal printer is described as an example; however, the present invention is also applicable to a light source device of a facsimile or a scanner, which is used for reading an original. In that case, it becomes possible to prevent a reduction in a light amount irradiated to side edge portions of the original.

Although the present invention has been described with respect to the preferred embodiment, the preset invention is not to be limited to the above embodiment but, on the contrary, various modifications will be possible to those skilled in the art without departing from the scope of claims appended hereto.

1. An optical fixing unit for optically fixing thermally recorded thermosensitive recording paper by irradiating fixing light to said thermosensitive recording paper, said optical fixing unit comprising:
a substrate; and
a light-emitting element array being formed of a plurality of light-emitting elements arranged on said substrate, said light-emitting element array having a length in accordance with a width of said thermosensitive recording paper, an arranging density of light-emitting elements being higher in side edge areas of said light-emitting element array facing side edge portions of said thermosensitive recording paper than in a center area of said light-emitting element array facing a center portion of said thermosensitive recording paper.

2. An optical fixing unit according to claim 1, wherein an arranging pitch between said light-emitting elements in a first direction of said light-emitting element array, which is approximately parallel to a width direction of said thermosensitive recording paper, is lessened from said center area toward said side edge areas.

3. An optical fixing unit according to claim 1, wherein an arranging pitch between said light-emitting elements in a second direction of said light-emitting element array, which is approximately perpendicular to a width direction of said thermosensitive recording paper, is lessened from said center area toward said side edge areas.

4. An optical fixing unit according to claim 1, further comprising:
reflectors being provided on both side edges of said light-emitting element array, said reflectors reflecting said fixing light radiated outside of a record area of said thermosensitive recording paper toward said record area.

5. An optical fixing unit for optically fixing thermally recorded thermosensitive recording paper by irradiating fixing light to said thermosensitive recording paper, said optical fixing unit comprising:
a substrate;
a light-emitting element array being formed of a plurality of light-emitting elements arranged on said substrate, said light-emitting element array having a length in accordance with a width of said thermosensitive recording paper, said light-emitting element array having a center area facing a center portion of said thermosensitive recording paper and side edge areas facing side edge portions of said thermosensitive recording paper; and
a pair of reflection planes being provided on both sides of each of said light-emitting element in a direction parallel to said width of said thermosensitive recording paper, said pair of reflection planes including a first reflection plane on said side edge area side and a second reflection plane on said center area side, and reflecting said fixing light radiated from a lateral surface of corresponding light-emitting element toward said thermosensitive recording paper, an angle of said first reflection plane with respect to a normal of said substrate being increased from said center area toward said side edge area of said light-emitting element array.

6. An optical fixing unit according to claim 5, wherein an angle of said second reflection plane with respect to said normal of said substrate becomes smaller from said center area toward said side edge areas of said light-emitting element array.

7. A light irradiating device for irradiating light to a sheet-like material, comprising:
a substrate; and
a light-emitting element array being formed of a plurality of light-emitting elements arranged on said substrate, said light-emitting element array having a length in accordance with a width of said sheet-like material, an arranging density of said light-emitting elements being higher in side edge areas facing side edge portions of said sheet-like material than in a center area facing a center portion of said sheet-like material.

8. A light irradiating device according to claim 7, wherein an arranging pitch between said light-emitting elements in a first direction of said light-emitting element array, which is approximately parallel to a width direction of said sheet-like material, is lessened from said center area toward said side edge areas of said light-emitting element array.

9. A light irradiating device according to claim 7, wherein an arranging pitch between said light-emitting elements in a second direction of said light-emitting element array, which is approximately perpendicular to a width direction of said sheet-like material, is lessened from said center area toward said side edge areas of said light-emitting element array.

10. A light irradiating device according to claim 7, further comprising:
reflectors being provided on both side edges of said light-emitting element array, said reflectors reflecting said fixing light irradiated outside of said sheet-like material toward said sheet-like material.

11. A light irradiating device for irradiating light to a sheet-like material, said light irradiating device comprising:
a substrate;
a light-emitting element array being formed of a plurality of light-emitting elements arranged on said substrate, said light-emitting element array having a length in accordance with a width of said sheet-like material, said light-emitting element array having a center area facing a center portion of said sheet-like material and side edge areas facing side edge portions of said sheet-like material; and
a pair of reflection planes being provided on both sides of each of said light-emitting element in a direction parallel to said width of said sheet-like material, said pair of reflection planes including a first reflection plane on said side edge area side and a second reflection plane on said center area side, and reflecting said fixing light radiated from a lateral surface of corresponding light-emitting element toward said sheet-like material, an angle of said first reflection plane with respect to a normal of said substrate being increased from said center area toward said side edge areas of said light-emitting element array.

12. A light irradiating device according to claim 10, wherein an angle of said second reflection plane with respect to a normal of said substrate becomes smaller from said center area toward said side edge areas of said light-emitting element array.
